(19) United States
(12) Patent Application Publication
(10) Pub. No.: US 2012/0298233 A1
(43) Pub. Date: Nov. 29, 2012

(54) MICROFLUIDIC COMPONENT FOR MANIPULATING A FLUID, AND MICROFLUIDIC CHIP

(75) Inventor: Peter Rothacher, Bruchsal (DE)

(73) Assignee: Robert Bosh GmbH, Stuttgart (DE)

(21) Appl. No.: 13/576,415

(22) PCT Filed: Dec. 30, 2010
(86) PCT No.: PCT/EP2010/070908

§ 371 Date: Aug. 1, 2012

(30) Foreign Application Priority Data
Feb. 1, 2010 (DE) 102010001412.5

(51) Int. Cl. G05D 16/06

(52) U.S. Cl. 137/613

(57) ABSTRACT

A microfluidic component for manipulating a fluid includes a first substrate, a second substrate, and a third substrate that is configured from a resilient material and arranged between the first substrate and the second substrate. At least one first recess that forms a first control chamber is configured on the face of the first substrate facing the third substrate. At least one second recess that forms a fluid channel is configured on the face of the second substrate facing the third substrate. A second control chamber that is spatially separated from the first control chamber and a control channel that connects the first control chamber to the second control chamber are formed in the first substrate. At least one lateral wall of the second control chamber is configured from resilient material and is deformable by an actuator such that the inner volume of the second control chamber decreases.

The invention relates to a microfluidic component for manipulating a fluid and to a microfluidic chip.

### PRIOR ART

Microfluidics deals with the manipulation of fluids, i.e. liquids or gasses, in very constrained spaces. In the process, fluids are moved, mixed, separated or processed in any other manner. Micropumps deliver or meter fluids, microvalves determine a direction or movement mode of pumped fluids and micromixers enable targeted mixing of fluid volumes. Microfluidic components are used, inter alia, in biotechnology and medical engineering.

The German patent application DE 10 2008 002 336.1-12, which is a prior publication, has disclosed a microfluidic component in the form of a pinch valve, which has a first, second and third substrate, wherein the third substrate is made of an elastic material and arranged between the first and second substrate. Here, the first substrate adjoins the third substrate and has at least one first recess on the side adjoining the third substrate. The second substrate likewise adjoins the third substrate and has at least one second recess on the side adjoining the third substrate. Here, the first recess and the second recess are arranged at least partly opposite one another. For the purposes of this disclosure, this prior application is incorporated into the present application in its entirety.

### DISCLOSURE OF THE INVENTION

The present invention provides a microfluidic component, more particularly a micropump, a microvalve or a micromixer, for manipulating a fluid, having a first substrate, a second substrate and a third substrate, which is arranged between the first substrate and the second substrate and made of an elastic material. At least one first recess is made in the side of the first substrate which faces the third substrate, said recess forming a first control chamber. At least one second recess is made in the side of the second substrate which faces the third substrate, said recess forming a fluid channel or a fluid chamber, which is for the fluid to be manipulated and at least in portions overlaps with the first control chamber. Additionally, a second control chamber, which is spatially separated from the first control chamber, and a control channel are made in the first substrate, with the control channel connecting the first control chamber to the second control chamber. The control chambers and the control channel form a closed system and are filled with a control fluid. At least one sidewall of the second control chamber is made of elastic material and can be deformed by an actuator, more particularly a mechanical activation member of an actuator, such that the internal volume of the second control chamber is reduced and, as a result thereof, the pressure in the control fluid increases.

The principle underlying the microfluidic component according to the invention is that the region of the third, elastic substrate arranged between the fluid channel or the fluid chamber and the first control chamber can, in the case of different pressures in the chambers, extend into the chamber with respectively lower pressure. By suitably arranging and configuring fluid channels or fluid chambers, this for example affords the possibility of implementing a micropump, a microvalve or a micromixer. Here, the first control chamber together with the second control chamber and the control channel interconnecting the two chambers forms a closed system, with a sidewall of the second control chamber being made of elastic material. As a result of the deformation of this sidewall, the internal volume of the second control chamber can be reduced and so the pressure in the closed system, and hence in the first control chamber as well, can be increased thereby. Here, the deformation of the deformable sidewall of the second control chamber required to activate the microfluidic component is implemented by an actuator, which can for example be driven electrically, magnetically, piezoelectrically or else by an electroactive polymer. Ultimately, the arrangement according to the invention leads to a spatial separation between the actuation system of the microfluidic component and the manipulation region of the fluid to be manipulated, i.e., for example, the valve region, the pump region or the mixing region. Only the first control chamber is arranged in the region of the actual micropump, the actual microvalve or the actual micromixer, while the second control chamber, which is acted upon by the actuation system, can be provided at any other position on a microfluidic chip, more particularly a biochip, on which the microfluidic component is implemented. It goes without saying that a plurality of microfluidic components according to the invention can also be arranged on one microfluidic chip.

This spatial separation between the actuation system and the actual manipulation location of the fluid enables an improved disentanglement of the control chambers and channels, which contain the control fluid in the chip, from the fluid chambers and channels, which hold the fluid to be manipulated in the chip. As a result of this it is, in turn, possible to position the second control chambers and hence the points of contact with the actuators at predefined, standardized positions of a microfluidic chip, and this makes it possible to activate different applications, i.e. different microfluidic components, using a standard actuation system.

It is also possible for a plurality of microfluidic components, e.g. microvalves, to be arranged on a chip with very small spacing between them. In the case of conventional actuation directly at the manipulation point there may be problems when designing the chip as a result of the actuation system, which is often relatively large. These problems are solved by separating the actuation system from the actual microfluidic components and the disentanglement of the chip enabled thereby.

The actuation of the microfluidic component implemented by deforming a sidewall of the second control chamber also leads to the actuator no longer needing to be integrated directly in the chip, but instead advantageously only being loosely connectable to the microfluidic component. Microfluidic components and the chips which carry them are often embodied as disposable cartridges, particularly in the case of application in the field of biotechnology or medical engineering. This loose connectability of the actuator to the microfluidic component and the separability of the two units after activation accompanying this make it possible to design the actuation system in the form of a reusable, preferably portable, control unit. In the case of an appropriate design of the chips, particularly in the case of appropriate arrangement of the second control chambers of the microfluidic components arranged on a chip, the control unit can even be used universally for different microfluidic chips, which significantly reduces the required financial expenditure. Here, the control unit can comprise a single actuator, optionally with a plurality of activation members, or else a plurality of actuators with respectively one or more activation members.

According to one embodiment of the invention, the second control chamber is formed by a third recess, which is made at a distance from the first control chamber in the side of the first substrate which faces the third substrate. The control channel can also likewise be formed by a recess which is made between the first and third recess in the side of the first substrate which faces the third substrate. These embodiments are advantageous from a manufacturing point of view in particular because the recesses can be implemented with little manufacturing complexity. However, it is also feasible for the second control chamber and/or the control channel not to be embodied as recesses in the side of the first substrate which faces the third substrate, but rather to be arranged in the interior of the first substrate. It is only the deformable sidewall of the second control chamber that has to be accessible from the outside.

According to a further embodiment of the invention, the deformable sidewall of the second control chamber is formed by the third substrate. By using the third substrate, which in any case has an elastic design, as a deformable sidewall of the second control chamber, a particularly simple design of the microfluidic component according to the invention is achievable, leading to relatively little production complexity. In order to actuate the microfluidic component, it is possible, on the one hand, to provide in the second substrate a passage opening which at least partly overlaps with the second control chamber and by means of which the actuator can directly act on the third substrate in a deforming manner. As an alternative thereto, provision can also be made on the side of the second substrate which faces away from the third substrate for a recess which at least partly overlaps with the second control chamber and the extent of which in the direction of the third substrate is set such that between the recess and the third substrate there is a web-like region of the second substrate, on which an actuator can act in a deforming manner. In this case, the deformation of the third substrate which serves as sidewall of the second control chamber is brought about indirectly via a deformation of the web-like region of the second substrate.

However, as an alternative thereto, the deformable sidewall of the second control chamber can also be formed directly by an outer wall of the first substrate.

The embodiments in which the actuator acts on a portion of the first or second substrate and not, or at least not directly, on the third substrate are particularly advantageous if relatively high restoring forces are required within the closed system filled with the control fluid.

Both gases and liquids can be used as control fluid. According to a preferred embodiment, air is used as control fluid, and so the microfluidic component is actuated pneumatically. This offers the advantage of being able to dispense with a complicated filling procedure for the control chambers and the control channel. In the case of using incompressible or almost incompressible liquids as control fluids, the volumes of the control chambers can be reduced compared to when they are filled with gases. However, on the other hand, this also results in higher flow resistances, which leads to an increase in the switching times.

If air is used as control fluid, then the microfluidic component can have an additional pressure compensation valve for compensating for the pressure difference at different heights (often also referred to as barometric pressure compensation), which pressure compensation valve, via a first pressure compensation channel (66), is connected to the first control chamber (4′), the second control chamber (8′) or the control channel (9′) and connected to the external surroundings via a second pressure compensation channel (67).

Further features and advantages of embodiments of the invention emerge from the following description with reference to the attached figures.

### BRIEF DESCRIPTION OF THE FIGURES

In detail:

FIG. 1 shows a schematic cross section through a first embodiment of a microfluidic component according to the invention in the form of a microvalve in a non-activated state,

FIG. 2 shows a schematic cross section through the first embodiment, shown in FIG. 1, of a component according to the invention in an activated state,

FIG. 3 shows a schematic cross section through a second embodiment of a microfluidic component according to the invention in the form of a microvalve in an activated state,

FIG. 4 shows a schematic cross section through a third embodiment of a microfluidic component according to the invention in the form of a microvalve in a non-activated state, and

FIG. 5 shows a schematic perspective illustration of a microfluidic chip according to the invention with a plurality of microfluidic components and associated actuators.

### DESCRIPTION OF THE EXEMPLARY EMBODIMENTS

In the figures, identical or functionally equivalent components are respectively denoted by the same reference sign.

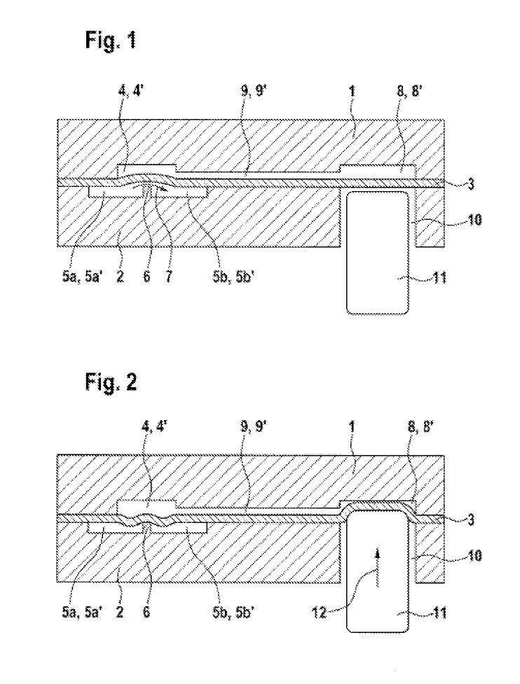

FIG. 1 shows a schematic cross section through a first embodiment of a microfluidic component according to the invention in the form of a microvalve in the non-activated state. The illustrated microvalve comprises a first substrate 1, a second substrate 2 and a third substrate 3, which is arranged between the first substrate and the second substrate. By way of example, the first and second substrate can be embodied from a thermoplastic. The third substrate 3 is made of an elastic material, more particularly a thermoplastic elastomeric film, and is arranged, more particularly sandwiched, between the first substrate 1 and the second substrate 2. Here, the first substrate 1 adjoins the third substrate 3 and, on the side adjoining the third substrate, has a first recess 4, which forms a first control chamber 4′. The second substrate 2 likewise adjoins the third substrate 3 and, on the side adjoining the third substrate 3, has two recesses 5a and 5b, which form fluid channels or fluid chambers 5a′ and 5b′ for the fluid to be manipulated. Here, the recesses 5a and 5b are arranged adjacent to one another and separated by a web 6, with both recesses 5a and 5b at least partly overlapping with the first recess 4. The shown embodiment is a so-called “normally on” microvalve. This means that the microvalve, which is embodied as a pinch valve in the illustrated exemplary embodiment, is open in the non-activated state, i.e. in the case of normal pressure in the first control chamber 4′, and is activated, and as a result partly or fully closed, by a pressure increase in the first control chamber 4′, as shown in FIG. 2. As illustrated schematically in FIG. 1, a pressure increase in the fluid to be manipulated in the recess 5a leads to the elastic substrate 3 extending into the first recess 4 and thus enabling a flow of the fluid to be manipulated out of the recess 5a and into the recess 5b (indicated by an arrow 7).

At a distance to the first recess, a further recess 8 is provided in the first substrate 1 and forms a second control chamber 8′. Provided between the first recess 4 and the third recess 8, there is a fourth recess 9, which serves as control channel 9′ and connects the first control chamber 4′ to the second control chamber 8′ such that the two control chambers 4′ and 8′ together with the control channel 9′ form a closed system. The two control chambers are advantageously embodied such that the second control chamber 8′ has a larger internal volume than the first control chamber 4′. The control channel 8′ has a smaller cross section than the two control chambers 4′ and 8′. The two control chambers 4′ and 8′ and also the control channel 9′ are filled with a control fluid, which can have a gaseous or liquid embodiment. Air is advantageously used a control fluid because this makes it possible to dispense with a complicated filling procedure of the two control chambers 4′ and 8′ and of the control channel 9′.

A passage opening 10 is provided in the second substrate 2 and in the illustrated exemplary embodiment it is arranged exactly opposite the second control chamber 8′. A mechanical activation member 11, for example in the form of a tappet, of an actuator (not illustrated in any more detail) can act in a deforming manner on the elastic substrate 3 via this passage opening 10. In the exemplary embodiment illustrated in FIGS. 1 and 2, the elastic substrate 3 forms an elastically deformable sidewall of the second control chamber 8′. If the mechanical activation member 11 of the actuator is pressed onto the elastic substrate 3 in the direction of the arrow 12 (FIG. 2), said substrate is moved into the second control chamber 8′. As a result there is a reduction in the internal volume of the second control chamber 8′, which in turn leads to a pressure increase in the control fluid in the closed system consisting of the two control chambers 4′ and 8′ and also the control channel 9′. The result of this pressure increase in the control fluid is that the elastic substrate 3 moves into the two recesses 5a and 5b in the region of the first control chamber 4′, which leads to the valve being closed. In the embodiment of a microfluidic component according to the invention shown in FIGS. 1 and 2, the passage opening 10 is embodied such that it has the same extent as the third recess 8 in the horizontal direction, i.e. in the direction parallel to the elastic substrate 3, and is arranged exactly opposite this recess 8. However, as an alternative thereto, the passage opening 10 can also be displaced with respect to the recess 9 in the horizontal direction and/or also have a smaller or larger horizontal extent. All that is decisive for the functionality is that the passage opening 10 at least partly overlaps with the recess 9 and so the activation member 11 can act on the elastic substrate 3 such that the elastic membrane 3 can be pressed into the region of the third recess 8. In respect of its horizontal extent, the passage opening 10 is advantageously made such that it simultaneously acts as guide for the activation member 11 of the actuator.

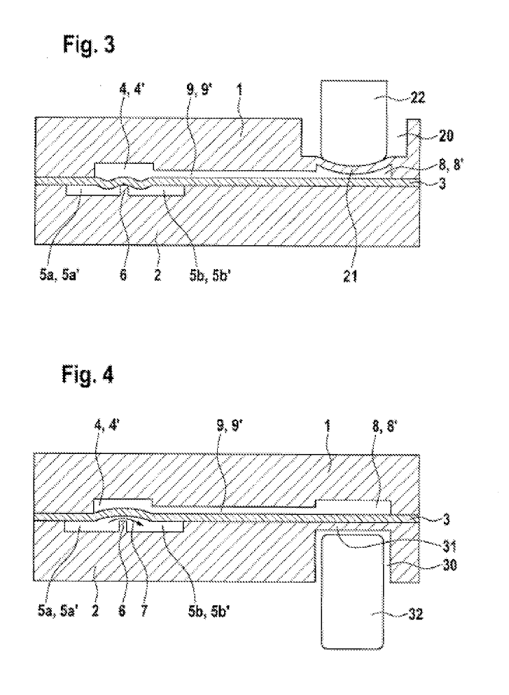

FIG. 3 shows an alternative embodiment of a microfluidic component according to the invention, which, analogously to FIGS. 1 and 2, is configured as a microfluidic pinch valve. However, in contrast to the first embodiment, no passage opening is provided in the second substrate 2, and so the elastic substrate 3 cannot be utilized as elastically deformable sidewall of the second control chamber 8′. Instead, a fifth recess 20 is provided in the first substrate 1 and arranged on the side of the first substrate which faces away from the third substrate 3, to be precise such that said recess overlaps at least in portions with the second control chamber 8′. Here, the depth of the recess, i.e. the extent of the fifth recess 20 in the direction toward the elastic substrate 3, is set such that a web-like region 21 of the first substrate 1 emerges between the fifth recess 20 and the second control chamber 8′; this web-like region on the one hand forms part of the outer wall of the first substrate 1 and on the other hand also serves as deformable sidewall of the second control chamber 8′. As a result of this, an activation member 22 of an actuator can act on the web-like region 21 of the first substrate such that the web-like region 21 is pressed into the region of the control chamber 8′. This in turn leads to a reduction in the internal volume of the second control chamber 8′, hence to an increase in the pressure in the control fluid and therefore ultimately to the valve being closed analogously to the first embodiment. In the embodiment illustrated in FIG. 3, the horizontal extent of the fifth recess 20 is embodied to be greater than the horizontal extent of the third recess 8. In this embodiment, it is alternatively also possible for the horizontal extent of the fifth recess 20 also to be the same size or smaller than the horizontal extent of the second control chamber 8′. In this case too, all that is decisive for the functionality is that the fifth recess 20 at least partly overlaps with the third recess 8 and so the activation member 11 can act on the web-like region 21 of the first substrate 1 such that the web-like region 21 can be pressed into the region of the third recess 8.

FIG. 4 shows a third embodiment of a microfluidic component according to the invention, which, analogously to FIGS. 1 to 3, is embodied as microfluidic pinch valve. However, in contrast to the first embodiment, no passage opening is provided in the second substrate 2, but merely a sixth recess 30, which is arranged on the side of the second substrate 2 which faces away from the third substrate 3, to be precise such that said recess overlaps at least in portions with the second control chamber 8′. Here, the depth of the recess, i.e. the extent of the sixth recess 30 in the direction toward the elastic substrate 3, is set such that a web-like region 31 of the second substrate 2 emerges between the sixth recess 30 and the third substrate; this web-like region forms a deformable part of the outer wall of the second substrate 2. An activation member 32 of an actuator can act on the web-like region 31 of the second substrate 2 such that the web-like region 31 is pressed in the direction of the third substrate 3 and, as a result, the third substrate 3 is pressed into the region of the control chamber 8′. This in turn leads to a reduction in the internal volume of the second control chamber 8′, hence to an increase in the pressure in the control fluid and therefore ultimately to the valve being closed analogously to the already described embodiment.

In addition to the embodiments illustrated in FIGS. 1 to 4, further alternative embodiments are feasible. Ultimately, all that is decisive is that the deformable sidewall of the second control chamber is accessible from the outside either directly or indirectly, for example via a web-like outer wall of the second substrate lying over the deformable sidewall, such that an actuator or an activation member of an actuator can act on this sidewall.

With reference to FIGS. 1 to 4, the invention was explained in exemplary manner for a microfluidic pinch valve. However, by appropriate adaptations in respect of the arrangement and embodiment of the fluid channels or fluid chambers 5a and 5b, and of the first control chamber 4′, a person skilled in the art is also readily able to implement other valve designs, or else micropumps or micromixers.

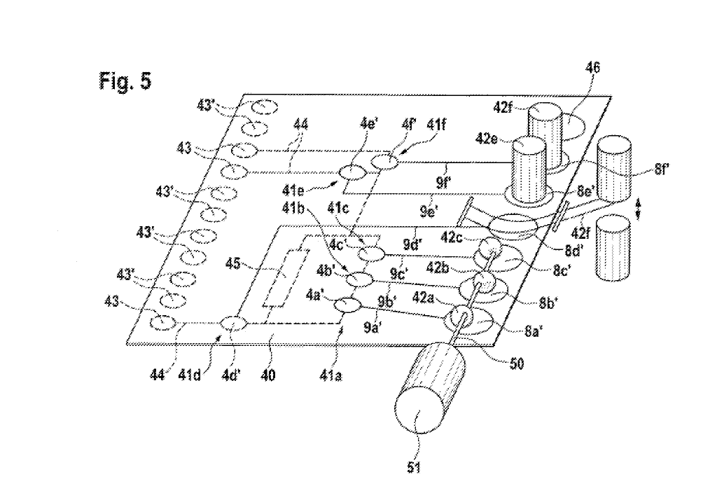

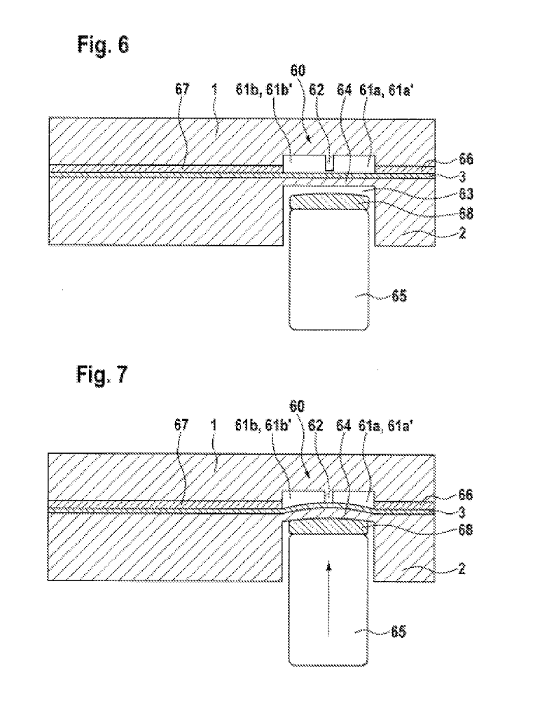

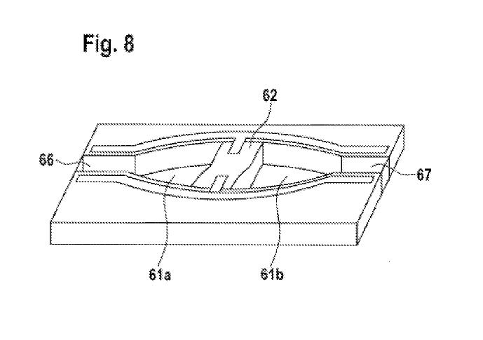

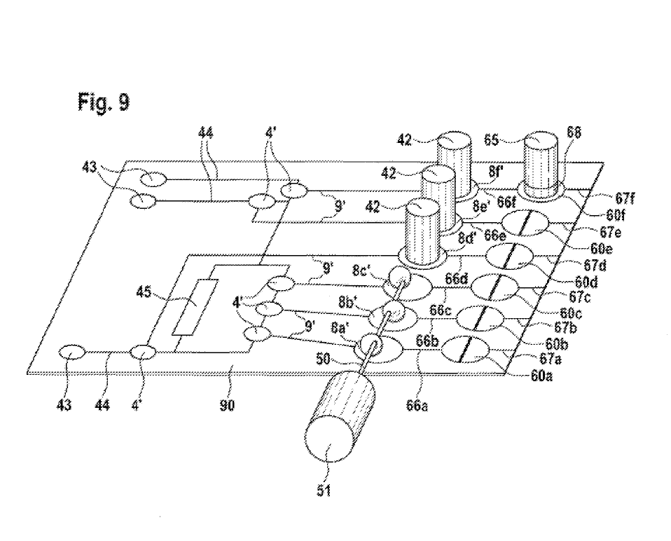

FIG. 5 schematically shows a perspective view of a microfluidic chip 40, more particularly a biochip, with a plurality of microfluidic components 41a-f according to the invention. In an exemplary fashion, the microfluidic components 41a-c are embodied as micropumps and the microfluidic components 41d-f are embodied as microvalves. In FIG. 5, those fluid channels and fluid chambers that carry the fluid to be manipulated are indicated by dashed lines. By contrast, the chambers and channels carrying the control fluid are indicated by solid lines. Here, the disentanglement, made possible by the microfluidic components according to the invention, of the controlling elements from the elements to be controlled, i.e. the elements that carry the fluid to be manipulated, is particularly clear. Thus, the second control chambers 8a′ to 8f′, on which the activation members 42a-f of an actuation system act, are arranged on the in the right-hand side of the chip in an exemplary fashion, while connectors 43 for the fluid to be manipulated are provided on the opposite left-hand side of the chip. As a result of suitable structuring of fluid channels 44 and fluid chambers 45 and also of the control channels 9a′ to 9f′ and first control chambers 4a′ to 4f′, this renders it possible to implement an actuation system of microfluidic chips with different switching, i.e. different arrangement and/or embodiment of the microfluidic components arranged on the chip, while having unchanging positioning of the fluid connectors and the contact points for the activation members. This enables a standard control unit, which holds an actuation system, to operate a multiplicity of different microfluidic chips. The actuation system is advantageously embodied such that it can be loosely connected to the chip or an individual microfluidic component, but can also be separated therefrom again. This is how the chip can be implemented as disposable cartridge, which is the norm, particularly in the biotechnological and medical engineering field of use. By contrast, the actuation system can be implemented in the form of a reusable, more particularly universally reusable, control unit. In the case of a purely pneumatic actuation, i.e. if the control chambers 4 and 8 and the control channels 9′ are filled with air, the control unit can for example be battery operated and be operated independently of pressurized-air sources or air pumps.

The actuators and the activation members thereof can have very varied designs. Thus, it is conceivable to provide a shaft 50, which is operated via an electric motor 51, optionally also in conjunction with gear ratios, deflection apparatuses, levers or eccentric rods. Here, the shaft 50 can be provided with appropriately designed eccentric disks, which serve as activation members 42a-c. By way of example, such an actuation system can be used for micropumps with continuous or partly continuous operation and is illustrated in FIG. 5 in an exemplary manner as actuation system for the micropumps 41a-c. Here, it also becomes clear that an actuator can also have a plurality of activation members for activating a plurality of microfluidic components. Moreover, it is also possible to use magnetic actuators, as illustrated in FIG. 5 in an exemplary manner for the microvalves 41d-f. Magnetic actuators furthermore also enable a bistable use. An actuator configured thus is illustrated schematically in FIG. 5 for the microvalve 41d. However, it is moreover also possible to apply other actuator principles, such as piezo-actuators, also based on piezoelectric polymers, or else electroactive polymers (EAPs). FIG. 5 also illustrates connectors 43′ for a fluid to be manipulated and a possible region of influence 46 of an additional actuator; however, these are not used in the illustrated switching of the chip.

If air is used as control fluid, the microfluidic component according to the invention can additionally have a pressure compensation valve, which serves for pressure compensation between the pneumatic system, consisting of the control chambers (4′, 8′) and the control channel (9′), and the external surroundings. A possible embodiment of such a pressure compensation valve is illustrated in FIGS. 6 and 7. Here, FIG. 6 shows a pressure compensation valve 60 in an open state and FIG. 7 shows the pressure compensation valve 60 in a closed state. In order to simplify the illustration, FIGS. 6 and 7 only illustrate the region of the microfluidic component in which the pressure compensation valve is illustrated.

In accordance with the illustrated embodiment of the pressure compensation valve 60, the first substrate 1 has two recesses 61a and 61b on the side adjoining the third substrate 3 and these form fluid channels 61a′ and 61b′ for the control fluid, i.e. for air. Here, the recesses 61a and 61b are arranged adjacent to one another and separated by a web 62. In the second substrate 2, provision is made for a further recess 63, which is arranged on the side of the second substrate 2 which faces away from the third substrate 3, to be precise such that at least in portions it overlaps with the two recesses 61a and 61b. Here, the depth of the recess, i.e. the extent of the further recess 63 in the direction toward the elastic substrate 3, is set such that a web-like region 64 of the second substrate 2 emerges between the further recess 63 and the third substrate; this web-like region forms a deformable part of the outer wall of the second substrate 2. An activation member 65 of an actuator can act on the web-like region 64 of the second substrate 2 such that the web-like region 64 is pressed in the direction of the third substrate 3 and hence the third substrate 3 is pressed against the web 62 between the two recesses 61a and 61b. This in turn leads to the pressure compensation valve being closed.

In order to enable pressure compensation between the pneumatic system and the external surroundings, the recess 61a is connected to the external surroundings via a first pressure compensation channel 66. This is achieved by virtue of the fact that the first pressure compensation channel 66 extends up to the edge of the microfluidic component or, in the case of a chip, up to the edge of the chip. The recess 61b is connected to the pneumatic system, i.e. to one of the control chambers 4′ or 8′ or to the control channel 9′, via a second pressure compensation channel 67. As a result of this, there is pressure compensation between the pneumatic system and the external surroundings when the pressure compensation valve is open. Before the microfluidic component or chip is put into operation, i.e. actuated, the pressure compensation valve 60 can then be sealed so that reliable functioning is ensured.

In order to ensure certain sealing of the pressure compensation valve 60, an elastic mold 68, e.g. in the form of an elastomeric pad, can be arranged on the side of the activation member which faces the web-like region 64 of the second substrate 2.

On the other hand, in order to ensure that the pressure compensation valve 60 in the open state certainly allows an airflow between the external surroundings and the pneumatic system of the microfluidic component, the web 62 between the two recesses 61a and 62b can have a slightly bent embodiment (see FIG. 8). Here, the curvature is configured such that the central region of the web has a greater distance from the third substrate 3 than the outer regions. In this respect, the web 62 has a concave design. Here, a web 62 embodied thus can be connected to the first substrate 1 with the aid of e.g. weld seams 80.

It goes without saying that, in addition to the embodiment of the pressure compensation valve 60 illustrated in FIGS. 6 to 8, further embodiments are also conceivable, which a person skilled in the art can readily implement by appropriate modifications in respect of arrangement and embodiment of the fluid channels 61a′ and 61b′ and of the recess 63.

Finally, FIG. 9 schematically shows a perspective view of a microfluidic chip 90 similar to the one as per FIG. 5, with provision being made for additional pressure compensation valves 60a-f, which are connected to the second control chambers 8a′ to 8f′ via first pressure compensation channels 66a-f and to the external surroundings of the chip via second pressure compensation channels 67a-f. For improved understanding, the webs 62a-f have also been indicated in the pressure compensation valves 60a-f, although these would not be visible in reality as a result of the web-like region 64 of the second substrate 2 in the case of an embodiment of the pressure compensation valves as per FIGS. 6 and 7. One of the activation members 65 of the pressure compensation valve has also been illustrated with an elastomeric pad 68 in an exemplary manner.

It goes without saying that a pressure compensation valve can be actively sealed before the microfluidic component on the chip is put into operation. However, the pressure compensation valve (60), the activation member (65) and the control unit are advantageously configured such that the pressure compensation valve (60) is automatically closed during the insertion into the control unit. By way of example, this can be achieved by using spring-forced pins or else fixedly attached rubber buffers.

1. A microfluidic component for manipulating a fluid, comprising:
a first substrate,
a second substrate, and
a third substrate arranged between the first substrate and the second substrate and made of an elastic material,
wherein at least one first recess is made in a side of the first substrate which faces the third substrate, said recess forming a first control chamber,
wherein at least one second recess is made in a side of the second substrate which faces the third substrate, said recess forming a fluid channel or a fluid chamber, which is configured to manipulate the fluid and at least in portions overlaps with the first control chamber,
wherein a second control chamber, which is spatially separated from the first control chamber, and a control channel, which connects the first control chamber to the second control chamber, are made in the first substrate,
wherein the first and second control chambers and the control channel are filled with a control fluid, and
wherein at least one sidewall of the second control chamber is made of elastic material and is configured to be deformed by an actuator such that an internal volume of the second control chamber is reduced.

2. The microfluidic component as claimed in claim 1, wherein the second control chamber is formed by a third recess, which is made in the side of the first substrate which faces the third substrate.

3. The microfluidic component as claimed in claim 2, wherein the control channel is formed by a fourth recess, which is made between the first recess and the third recess in the side of the first substrate which faces the third substrate.

4. The microfluidic component as claimed in claim 1, wherein the deformable sidewall of the second control chamber is formed by the third substrate.

5. The microfluidic component as claimed in claim 1, wherein the deformable sidewall of the second control chamber is formed by an outer wall of the first substrate.

6. The microfluidic component as claimed in claim 1, wherein a gaseous fluid is used as the control fluid.

7. The microfluidic component as claimed in claim 6, wherein air is used as the control fluid and at least one seventh recess is made in the side of the first substrate which faces the third substrate, said seventh recess forming a pressure compensation valve, which, via a first pressure compensation channel, is connected to the first control chamber, the second control chamber or the control channel and is connected to the external surroundings via a second pressure compensation channel.

8. The microfluidic component as claimed in claim 1, wherein the microfluidic component is configured to be loosely connected to the actuator.

9. The microfluidic component as claimed in claim 1, wherein the actuator is driven electrically or magnetically or piezoelectrically or by an electroactive polymer.

10. A microfluidic chip, comprising:
at least one microfluidic component configured to manipulate a fluid, the at least one microfluidic component including:
a first substrate,
a second substrate, and
a third substrate arranged between the first substrate and the second substrate and made of an elastic material,
wherein at least one first recess is made in a side of the first substrate which faces the third substrate, said recess forming a first control chamber,
wherein at least one second recess is made in a side of the second substrate which faces the third substrate, said recess forming a fluid channel or a fluid chamber, which is configured to manipulate the fluid and at least in portions overlaps with the first control chamber,
wherein a second control chamber, which is spatially separated from the first control chamber, and a control channel, which connects the first control chamber to the second control chamber, are made in the first substrate,
wherein the first and second control chambers and the control channel are filled with a control fluid, and
wherein at least one sidewall of the second control chamber is made of elastic material and is configured to be deformed by an actuator such that an internal volume of the second control chamber is reduced.

11. The microfluidic chip as claimed in claim 10, wherein the microfluidic chip includes at least two microfluidic components, and wherein the second control chambers of the microfluidic components are arranged on the chip at standardized positions.

12. The microfluidic chip as claimed in claim 11, wherein the chip is configured to be actuated by a universal control unit which comprises one or more actuators.

13. The microfluidic chip as claimed in claim 12, wherein the at least one microfluidic component uses air as the control fluid and has a pressure compensation valve, and wherein the pressure compensation valve, an activation member of an actuator of the pressure compensation valve, and the control unit are configured such that the pressure compensation valve is automatically closed during an insertion into the control unit.

14. The microfluidic component as claimed in claim 1, wherein the microfluidic component is configured as a micropump, a microvalve, or a micromixer.

15. The microfluidic component as claimed in claim 1, wherein the at least one sidewall of the second control chamber is configured to be deformed by a mechanical activation member of the actuator.

16. The microfluidic chip as claimed in claim 10, wherein the microfluidic chip is configured as a biochip.
